(19) United States
(12) Patent Application Publication
(10) Pub. No.: US 2026/0302449 A1
(43) Pub. Date: Oct. 1, 2026

(54) SECONDARY BATTERY AND METHOD OF MANUFACTURING SECONDARY BATTERY

(71) Applicant: SAMSUNG SDI CO., LTD., Yongin-si (KR)

(72) Inventors: Sanghyun KIM, Yongin-si (KR); Jeongchull AHN, Yongin-si (KR); Hiroshi SEINO, Yongin-si (KR); Daesik KIM, Yongin-si (KR)

(21) Appl. No.: 19/563,216

(22) Filed: Mar. 11, 2026

(30) Foreign Application Priority Data
Mar. 26, 2025 (KR) 10-2025-0038644

(51) Int. Cl. H01M 50/169; H01M 10/04; H01M 50/103; H01M 50/119; H01M 50/159

(52) U.S. Cl. CPC H01M 50/169; H01M 10/0431; H01M 50/103; H01M 50/119; H01M 50/159

(57) ABSTRACT

A secondary battery, includes an electrode assembly, and a case in which the electrode assembly is accommodated, wherein the case includes a body includes an accommodation part for accommodating the electrode assembly and an extension part extending from a circumference of an open end of the accommodation part, a cover coupled with the extension part to seal the open end of the accommodation part to form a flange part, and a binding line disposed on the flange part, wherein the binding line includes a binding part that binds the extension part and the cover, and a venting part that is fracturable by a predetermined internal pressure of the sealed accommodation part, and a portion of the flange part on which the venting part is disposed is more concave than a remaining portion of the flange part on which the binding part is disposed.

### CROSS-REFERENCE TO RELATED APPLICATION

The present application claims priority to and the benefit of Korean Application No. 10-2025-0038644, filed on Mar. 26, 2025, in the Korean Intellectual Property Office, the entire disclosure of which is incorporated by reference herein.

### BACKGROUND

### Field

The present disclosure relates to a secondary battery and a method of manufacturing a secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

When a secondary battery is exposed to a high-temperature environment or a short circuit occurs, a swelling phenomenon may occur of which the secondary battery swells from gas that is generated inside a case of the secondary battery due to electrolyte decomposition and electrode reactions inside the case. Due to this, the case of the secondary battery may rupture, which may cause ignition or explosion due to thermal runaway. This may not only cause performance degradation of the battery but also may cause serious safety problems. In order to suppress such a phenomenon, a vent, which is intentionally fractured to discharge gas inside the case when a pressure greater than or equal to a certain pressure, is formed inside the case, which improves the design of a secondary battery.

The above information disclosed in this Background section is for enhancement of understanding of the background of the present disclosure, and therefore, it may contain information that does not constitute related (or prior) art.

### SUMMARY

An object to be solved by the present disclosure is to provide a case for a secondary battery for solving the technical problem described above and to provide a secondary battery including the same.

These and other aspects and features of the present disclosure will be described in or will be apparent from the following description of embodiments of the present disclosure.

A secondary battery according to some embodiments of the present disclosure may comprise an electrode assembly comprising a first electrode, a second electrode, and a separator disposed between the first electrode and the second electrode and a case to accommodate the electrode assembly. The case may comprise a body comprising an accommodation part for accommodating the electrode assembly and an extension part extending from an open end of the accommodation part around a circumference of the open end of the accommodation part, a cover coupled with the extension part to seal the open end of the accommodation part, the cover and the open end of the accommodation part configured to form a flange part when coupled together, and a binding line on the flange part. The binding line may comprise a binding part that binds the extension part and the cover and a venting part that may be fracturable by a predetermined internal pressure of the accommodation part when sealed. A portion of the flange part in which the venting part may be disposed may be more concave than a remaining portion of the flange part where the binding part may be located.

In some embodiments, the electrode assembly may be of a jelly roll shape of which the first electrode, the separator, and the second electrode may be wound, in that order. From a planar view of the flange part, the venting part may be located in a plane of a winding axis direction of the jelly roll shape.

In some embodiments, the secondary battery may further comprise a first electrode terminal disposed on one side surface of the body and electrically connected to the first electrode and a second electrode terminal disposed on a same side surface of the body as the first electrode terminal and electrically connected to the second electrode.

In some embodiments, the venting part may be disposed in a portion of the flange part located on a same side surface of the body as the first electrode terminal and the second electrode terminal.

In some embodiments, the flange part may comprise a first portion corresponding to a position of the first electrode terminal and a second portion corresponding to a position of the second electrode terminal. The portion of the flange part in which the venting part may be disposed may be between the first portion and the second portion.

In some embodiments, a width of the portion of the flange part in which the venting part may be disposed may be from about 10% to about 50% of a width of the remaining portion of the flange part where the binding part may be located.

In some embodiments, a width of the portion of the flange part in which the venting part may be disposed may be from about 0.05 mm to about 0.1 mm. A width of the remaining portion of the flange part where the binding part may be located may be from about 0.2 mm to about 0.3 mm.

In some embodiments, the binding line may comprise a welded part where the extension part and the cover may be joined by welding.

In some embodiments, a portion of the welded part excluding the venting part may comprise a plurality of first weld beads. The venting part may comprise a plurality of second weld beads comprising a weaker bonding strength than the plurality of first weld beads.

In some embodiments, a diameter of each second weld bead of the plurality of second weld beads may be less than a diameter of each first weld bead of the plurality of first weld beads.

In some embodiments, an interval between center points of adjacent second weld beads of the plurality of second weld beads may be greater than an interval between center points of adjacent first weld beads the plurality of first weld beads.

In some embodiments, a welding depth of the plurality of second weld beads may be less than a welding depth of the plurality of first weld beads.

In some embodiments, second weld beads forming the plurality of second weld beads may be positioned in a single row. First weld beads forming the plurality of first weld beads may be positioned in two parallel rows.

In some embodiments, the binding line may comprise an adhesive part where the extension part and the cover may be joined by an adhesive.

In some embodiments, a portion of the adhesive part excluding the venting part may comprise a first adhesive part. The venting part may comprise a second adhesive part. A width of the second adhesive part may be less than a width of the first adhesive part.

In some embodiments, the body and the cover may comprise a same metallic material.

In some embodiments, the body and the cover comprise stainless steel.

A method of manufacturing a secondary battery according to the present disclosure may comprise providing an electrode assembly comprising a first electrode, a second electrode, and a separator disposed between the first electrode and the second electrode, inserting the electrode assembly into a case via an open end of an accommodation part of a body of the case, forming a flange part of the case, the flange part comprising a binding line that joins an extension part extending from a circumference of the open end of the accommodation part, and forming a cover of the case to seal the open end of the accommodation part. The binding line may be configured to comprise a binding part for binding the extension part and the cover, and a venting part that may be fracturable by a predetermined internal pressure of the sealed accommodation part. A portion of the flange part in which the venting part may be disposed may be configured to be more concave than a remaining portion of the flange part where the binding part may be located.

In some embodiments, the forming the flange part may comprise cutting the portion of the flange part in which the venting part may be disposed to be more concave than the remaining portion of the flange part where the binding part may be located.

In some embodiments, the providing may comprise forming the electrode assembly in a jelly roll shape by sequentially winding the first electrode, the separator, and the second electrode. The method may further comprise positioning the venting part such that, from a planar view of the flange part, the venting part may be located in a plane of a winding axis direction of the jelly roll shape.

According to some embodiments of the present disclosure, a case for a secondary battery that may prevent thermal runaway, due to an increase in internal pressure from an abnormal behavior of the secondary battery, without a separate additional components or methods to achieve the same and a secondary battery including the aforementioned case may be provided.

According to some embodiments of the present disclosure, in a process of joining a body, in which an electrode assembly of a secondary battery is accommodated, and a cover by welding or applying an adhesive, a vent (or a venting part) that discharges internal gas may be formed by partially changing a shape of a flange part of the case.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a schematic diagram illustrating a secondary battery according to some embodiments of the present disclosure.

FIG. 2 is a plan view schematically illustrating a secondary battery according to some embodiments of the present disclosure.

FIG. 3 is a diagram illustrating a perspective view of a portion of the secondary battery of FIG. 2, taken along line A-A’ according to some embodiments of the present disclosure.

FIG. 4 is a cross-sectional view of a case for a secondary battery and a binding line of the case for the secondary battery according to some embodiments of the present disclosure.

FIG. 5 is a diagram illustrating a case for a secondary battery according to some embodiments of the present disclosure.

FIG. 6 is a diagram illustrating a case for a secondary battery according to some embodiments of the present disclosure.

FIG. 7 is a diagram illustrating a case for a secondary battery according to some embodiments of the present disclosure.

FIG. 8 is a diagram illustrating a case for a secondary battery according to some embodiments of the present disclosure.

FIG. 9 is a cross-sectional view of a case for a secondary battery and a binding line of the case for the secondary battery according to some embodiments of the present disclosure.

FIG. 10 is a diagram illustrating a case for a secondary battery according to some embodiments of the present disclosure.

FIG. 11 is a flowchart illustrating a method for manufacturing a secondary battery according to some embodiments of the present disclosure.

FIG. 12 is a diagram illustrating a step of welding a case for a secondary battery according to some embodiments of the present disclosure.

FIG. 13 is a diagram illustrating a step of cutting a flange part according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.”

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

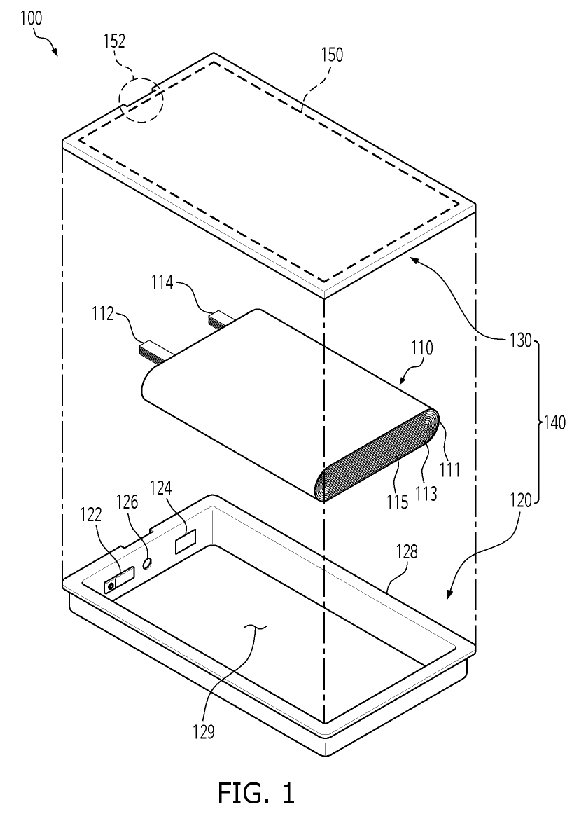

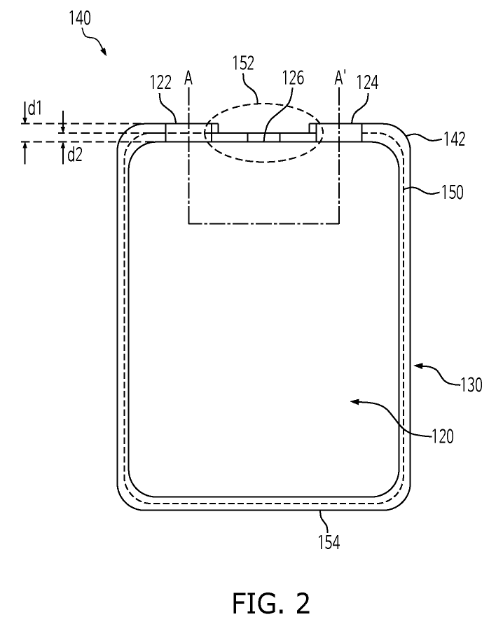

FIG. 1 is a schematic diagram illustrating a secondary battery according to some embodiments of the present disclosure. FIG. 2 is a plan view schematically illustrating a secondary battery according to some embodiments of the present disclosure.

A secondary battery 100 according to some embodiments of the present disclosure may include an electrode assembly 110 having a first electrode 111, a second electrode 113, and a separator 115 disposed between the first electrode 111 and the second electrode 113 and may include a case 140 in which the electrode assembly 110 is accommodated.

According to some embodiments, the electrode assembly 110 may be formed by sequentially winding or stacking a first electrode 111, a separator 115, and a second electrode 113. The electrode assembly 110 may be formed in a jelly roll shape by sequentially winding the first electrode 111, the separator 115, and the second electrode 113, and a cavity in which the first electrode 111, the separator 115, and the second electrode 113 are not present may be formed inside the jelly roll shape (i.e., the cavity may be a core part of the electrode assembly in the jelly roll shape).

The first electrode 111 may be an electrode corresponding to a positive electrode or a negative electrode in the electrode assembly 110. The second electrode 113 may be an electrode corresponding to a pole opposite to the first electrode 111. For example, when the first electrode 111 is a positive electrode, the second electrode 113 may be a negative electrode. Conversely, when the first electrode 111 is a negative electrode, the second electrode 113 may be a positive electrode.

The electrode assembly 110 may be impregnated with an electrolyte (not shown). The electrolyte may be, for example, a liquid electrolyte, a solid electrolyte, a gel electrolyte, or a combination thereof.

The positive electrode and the negative electrode may include a coated portion in which a current collector formed of a thin film foil coated with an active material and a non-coated portion in which a current collector is not coated with an active material. The positive electrode and the negative electrode are wound with an insulating separator interposed therebetween. However, the present disclosure is not limited thereto, and the electrode assembly may have a structure in which positive electrodes and negative electrodes formed of a plurality of sheets are alternately stacked with a separator interposed therebetween.

A positive electrode for a rechargeable lithium battery may include a current collector and a positive electrode active material layer on the current collector. The positive electrode active material layer may include a positive electrode active material and may further include a binder and/or a conductive material (e.g., an electrically conductive material).

For example, the positive electrode may further include an additive that may serve as a sacrificial positive electrode.

An amount of the positive electrode active material may be about 90 wt% to about 99.5 wt% based on 100 wt% of the positive electrode active material layer. Amounts of the binder and the conductive material may be about 0.5 wt% to about 5 wt%, respectively, based on 100 wt% of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons may be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector but is not limited thereto.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The negative electrode for a rechargeable lithium battery may include a current collector and a negative electrode active material layer on the current collector. The negative electrode active material layer may include a negative electrode active material and may further include a binder and/or a conductive material (e.g., an electrically conductive material).

For example, the negative electrode active material layer may include about 90 wt% to about 99 wt% of the negative electrode active material, about 0.5 wt% to about 5 wt% of the binder, and about 0 wt% to about 5 wt% of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons may be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless-steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof but is not limited thereto.

The organic material and the inorganic material may be mixed in one coating layer, or a coating layer including an organic material and a coating layer including an inorganic material may be stacked.

The case 140 forms an overall appearance of the secondary battery and may be formed of a conductive metal such as aluminum, an aluminum alloy, or nickel-plated steel. Specifically, a body 120 of the case and a cover 130 of the case may be composed of a same metallic material. The metallic material may include stainless use steel (SUS) or aluminum (Al). However, a use of such metallic materials is exemplary, and the case 140 may be composed of various metallic materials that satisfy the strength required for the secondary battery and resistance to external impact.

The case 140 may include a body 120 including an accommodation part 129 for accommodating the electrode assembly 110 and an extension part 128 extending from an open end of the accommodation part 129 around a circumference of the open end of the accommodation part 129, a cover 130 coupled with the extension part 128 to seal the open end of the accommodation part 129, forming a flange part 142 when the cover 130 and the open end of the accommodation part 129 are coupled together, and a binding line 150 on the flange part 142.

The flange part 142 may be formed to extend outward from the open end of the accommodation part 129. The flange part 142 may be formed extending from an edge of the open end of the accommodation part 129. The flange part 142 may extend substantially parallel to the bottom of the accommodation part 129, but the flange part 142 is not limited thereto.

The flange part 142 may have a predetermined width. In some embodiments, the flange part 142 may have a predetermined width in a direction away from the accommodation part 129 from one side of the accommodation part 129. The direction away from the accommodation part 129 from one side of the accommodation part 129 may be a width direction of the flange part 142.

The width of the flange part 142 may be different for each region of the flange part 142. The accommodation part 129 may have an upper surface (e.g., one surface of the accommodation part 129 on which at least one of a first electrode terminal 122, a second electrode terminal 124, or an electrolyte injection port 126 is formed), a lower surface (e.g., one surface facing the upper surface), and a side surface (e.g., a surface connected to the upper surface and the lower surface). A width of the flange part 142 in contact with the upper surface and/or the lower surface of the accommodation part 129 may be greater than a width of the flange part 142 in contact with the side surface of the accommodation part 129. In some embodiments, a width of the flange part 142 in contact with a vertex of the accommodation part 129 may be greater than a width of the flange part 142 in contact with the side surface of the accommodation part 129.

The body 120 may include an accommodation part 129 with one end open to accommodate the electrode assembly 110. The accommodation part 129 of the body 120 may have an internal space in which the electrode assembly is accommodated by press working or the like. A planar shape of the accommodation part 129 of the body 120 may be, for example, a quadrangular shape, but the shape of the accommodation part 129 is not limited thereto.

The cover 130 may be configured as a flat plate disposed on the extension part 128 of the body 120 to seal the open end of the accommodation part 129. The cover 130 may be a flat plate having a size sufficient to cover the extension part 128 and may be in surface contact with the extension part 128. A lower surface of the cover 130 and an upper surface of the extension part 128 may be disposed to be in surface contact with each other. By coupling the extension part 128 and the cover 130, the body 120 and the cover 130 may form a single structure.

The case 140 may include a binding line 150 on the extension part 128 and the cover 130 corresponding to the extension part 128.

The binding line 150 may refer to a partial region where the extension part 128 and the cover 130 are integrated in the flange part 142 formed by coupling the extension part 128 and the cover 130 to each other so as to seal the accommodation part 129.

In some embodiments, the binding line 150 may be in a substantially middle region of the flange part 142 formed along a circumference of the case 140. The flange part 142 may have an inner side that is in contact with the accommodation part 129 and an outer side that faces an outside of the case 140. The middle region may be located between the inner side and the outer side of the flange part 142.

In some embodiments, the binding line 150 may correspond to a region having a predetermined width in a width direction of the flange part 142. A width of the binding line 150 may be from about 30% to about 70%, from about 40% to about 60%, or from about 45% to about 55% of a width of the flange part 142.

The binding line 150 may include a welded part where the extension part 128 and the cover 130 are joined by welding via a laser welder. Additionally, or alternatively, the binding line 150 may include an adhesive part where the extension part 128 and the cover 130 are joined to each other by an adhesive. The binding line 150 may be along an edge of the cover 130 and the extension part 128 that form the flange part 142.

Specifically, the binding line 150 may include a binding part 154 that binds the extension part 128 and the cover 130, and a venting part 152 that is fracturable by a predetermined internal pressure of the sealed accommodation part 129.

A bonding strength of the venting part 152 may be weaker than a bonding strength of a portion of the binding line 150 excluding the venting part 152, that is, the binding part 154. Through this, the venting part 152 may be fractured in a situation of thermal runaway due to an increase in internal pressure according to an abnormal behavior of the secondary battery, thereby reducing pressure inside the case 140 or in the accommodation part 129. The venting part 152 may be formed at any position among the positions where the binding line 150 is. A position of the venting part 152 according to the present disclosure is not limited to the position illustrated in FIG. 1 and may have various modifications.

A portion of the flange part 142 in which the venting part 152 is disposed may have a concave shape in a width direction of the flange part 142 compared to a remaining portion of the flange part 142 where the binding part 154 is located. A width d2 of the portion of the flange part 142 on which the venting part 152 is disposed may be less than a width d1 of a remaining portion of the flange part 142 where the binding part 154 is located. Due to this, a partial region of the flange part 142 in which the venting part 152 is disposed may be concave.

The width d2 of the portion of the flange part 142 in which the venting part 152 is disposed may be from about 10% to about 50%, from about 16.7% to about 33.3%, or from about 25% to about 30% of the width d1 of a remaining portion of the flange part 142 where the binding part 154 is located. According to some embodiments, a width of the portion of the flange part 142 in which the venting part 152 is disposed may be from about 0.05 mm to about 0.1 mm, and a width of the remaining portion of the flange part 142 where the binding part 154 is located may be from about 0.2 mm to about 0.3 mm.

Through this, a width of the flange part 142 surrounding the binding line 150 of the venting part 152 may be shorter than a width of the flange part 142 surrounding the binding line 150 of the binding part 154. Alternatively, the binding line 150 of the venting part 152 may not be surrounded by the flange part 142 and may be exposed to the outside.

According to some embodiments, the case 140 may include an electrolyte injection port 126. The electrolyte injection port 126 may be a through-hole formed on at least one side surface of the case 140 and may inject an electrolyte into the case 140 after the body 120 and the cover 130 are joined and sealed. The electrolyte injection port 126 may be sealed with a sealer after the electrolyte is injected.

In some embodiments, the secondary battery 100 may further include a first electrode terminal 122 disposed on one side surface of the body 120 and electrically connected to the first electrode 111 through a first electrode tab 112, and a second electrode terminal 124 disposed on one side surface of the body 120 and electrically connected to the second electrode 113 through a second electrode tab 114.

The first electrode terminal 122 and the second electrode terminal 124 may be coupled to the body 120. The first and second electrode terminals 122 and 124 may be disposed on at least one side surface of the case 140, specifically, on at least one side surface of the body 120. A position of the first and second electrode terminals 122 and 124 according to the present disclosure is not limited to the position illustrated in FIG. 1 and may have various modifications.

When the electrode assembly 110 is formed in a jelly roll shape by sequentially winding the first electrode 111, the separator 115, and the second electrode 113, the first electrode tab 112 may be disposed on a plane of the wound first electrode 111 and attached so that a part of the first electrode tab 112 protrudes to an outside of the jelly roll shape. In addition, the second electrode tab 114 may also be disposed on a plane of the wound second electrode 113 and may be attached so that a part of the second electrode tab 114 protrudes to the outside of the jelly roll shape. A protrusion direction of the first electrode tab 112 and the second electrode tab 114 may coincide with a winding axis direction of the jelly roll shape. Through this, the first electrode terminal 122 connected to the first electrode tab 112 and the second electrode terminal 124 connected to the second electrode tab 114 may protrude from the body 120 in the winding axis direction of the jelly roll shape.

Based on the first electrode terminal 122 and the second electrode terminal 124, the venting part 152 may be disposed at various positions on the flange part 142 of the case 140. According to some embodiments, the venting part 152 may be disposed on a portion of the flange part 142 located on one side surface of the body 120 on which the first electrode terminal 122 and the second electrode terminal 124 are disposed. From a planar view of the flange part 142, the venting part 152 may be located in a plane of a winding axis direction of the jelly roll shape.

According to some embodiments of the present disclosure, a case 140 for a secondary battery that may prevent thermal runaway due to an increase in internal pressure according to an abnormal behavior of the secondary battery 100 without a separate additional process and a secondary battery 100 including the same may be provided.

According to some embodiments of the present disclosure, in a process of joining a body 120, in which an electrode assembly 110 of a secondary battery 100 is accommodated, and a cover 130 by welding or applying an adhesive, a vent (or a venting part 152) that may discharge internal gas may be formed only by partially changing a shape of a flange part 142.

The secondary battery 100 may be a secondary battery composed of a Stainless Use Steel (SUS) material, but the secondary battery according to the present disclosure is not limited thereto and may be one of various types of secondary batteries including a prismatic secondary battery composed of an aluminum material.

The secondary battery 100 may be a lithium battery cell, a sodium battery cell, or the like. However, the scope of the present disclosure is not limited thereto, and the secondary battery 100 includes all batteries that may repeatedly provide electricity by charging and discharging. In some embodiments, when the secondary battery 100 is a lithium battery cell, the secondary battery 100 may be used in an electric vehicle (EV) because of excellent cycle life characteristics of the lithium battery cells and high-rate characteristics of lithium battery cells. The secondary battery 100 may be used in a hybrid vehicle such as a plug-in hybrid electric vehicle (PHEV). In addition, the lithium battery cell may be used in fields requiring power storage in a wide range, for example, it may be used in a smartphone, a tablet PC, an electric bicycle, a power tool, etc., but the lithium battery cell is not limited thereto.

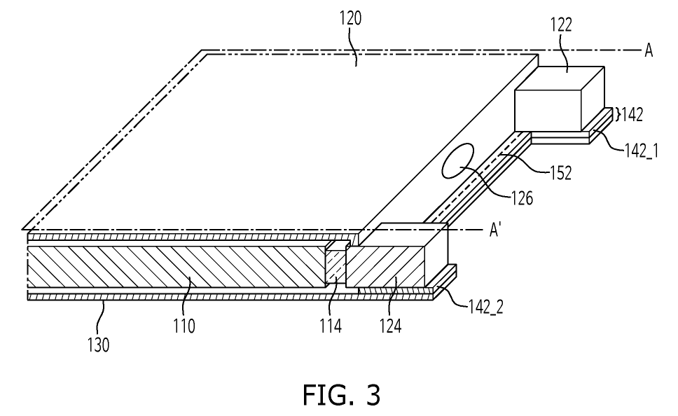

FIG. 3 is a diagram illustrating a perspective view of a portion of the secondary battery of FIG. 2 taken along line A-A’ according to some embodiments of the present disclosure.

An extension part of the body 120 and the cover 130 may be coupled to each other to form a flange part 142. A first electrode terminal 122 and a second electrode terminal 124 may be disposed on at least one side surface of the body 120. The first electrode terminal 122 may be connected to the electrode assembly 110 through a first electrode tab (not shown), and the second electrode terminal 124 may be connected to the electrode assembly 110 through a second electrode tab 114. An electrolyte injection port 126 may be formed in the body 120 and/or the cover 130.

According to some embodiments, the venting part 152 may be disposed on a portion of the flange part 142 located on one side surface of the body 120 on which the first electrode terminal 122 and the second electrode terminal 124 are disposed.

The flange part 142 may include a first portion 142_1 corresponding to a position of the first electrode terminal 122 and a second portion 142_2 corresponding to a position of the second electrode terminal 124, and the venting part 152 may be disposed between the first portion 142_1 and the second portion 142_2. A portion of the flange part 142 disposed between the first portion 142_1 and the second portion 142_2 may be more concave than a remaining portion of the flange part 142.

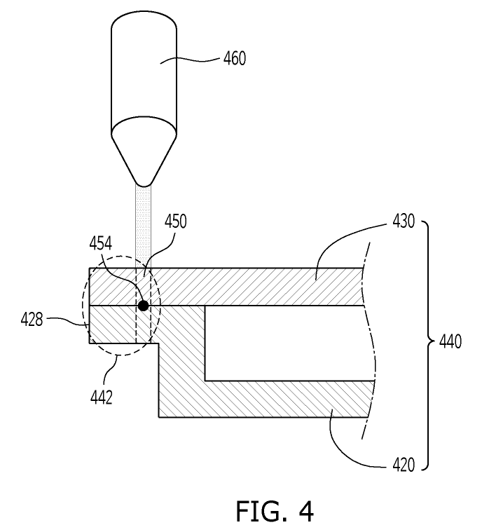

FIG. 4 is a cross-sectional view of a case for a secondary battery and a binding line of the case for the secondary battery according to some embodiments of the present disclosure.

Referring to FIG. 4, a joint line 450 according to some embodiments may include a welded part 454 where an extension part 428 and a cover 430 are joined by welding. The welded part 454 may refer to a point where the extension part 428 and the cover 430 are integrally joined by welding in a flange part 442 formed by coupling the extension part 428 of a body 420 and the cover 430 to each other so as to seal an accommodation part 129. By the welded part 454, the body 420 and the cover 430 of the secondary battery may be joined by welding to form a case 440 which is a single joined structure.

In some embodiments, an edge or an outermost region of the cover 430 may be joined by welding with the extension part 428 of the body 420 through a welder 460. The cover 430 and the extension part 428 may be joined by welding through laser welding, and, in this process, the joint line 450 may include the welded part 454 where the extension part 428 and the cover 430 are joined to each other by welding.

In some embodiments, the welded part 454 may be formed on a surface between the body 420 and the cover 430 by welding. The welded part 454 may have different bonding strengths for each welded portion or for each position. Thus, the welder 460 may be controlled to generate weld beads having different bonding strengths for different positions of the welded part 454. Through such control, the welded part 454 may have different bonding strengths at a venting part and a binding part.

However, in the present disclosure, the above-mentioned joining method is not limited to above-described embodiments, and various joining methods that may seal the case 440 may be used. The cover 430 and the extension part 428 may be joined by not only laser welding but also ultrasonic welding, brazing, laser brazing, welding, soldering, and the like.

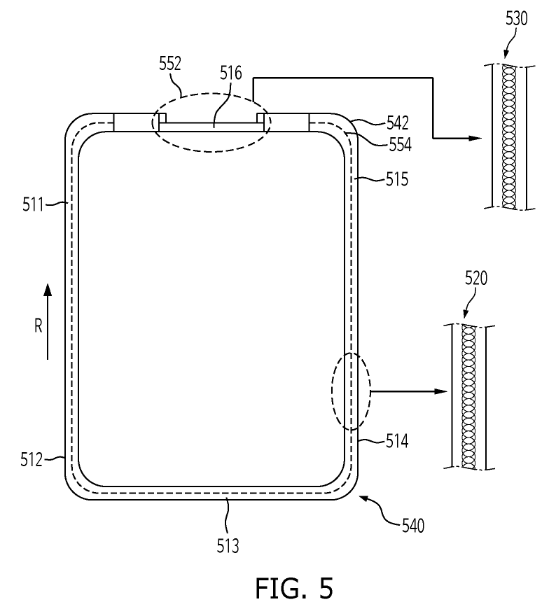

FIG. 5 is a diagram illustrating a case 540 for a secondary battery according to some embodiments of the present disclosure.

Referring to FIG. 5, a welded part 554 may be formed along an edge or an outermost region of a case 540. A venting part 552 may be configured to be fracturable by a predetermined pressure inside the case 540.

The venting part 552 may be formed at any position among the positions where the welded part 554 is formed. The venting part 552 may be formed at one or more of a first position 511, a second position 512, a third position 513, a fourth position 514, a fifth position 515, and a sixth position 516.

According to some embodiments, an electrode assembly accommodated inside the case 540 is formed in a jelly roll shape by sequentially winding a first electrode, a separator, and a second electrode, and from a planar view of a flange part 542, the venting part 552 may be located in a plane of a winding axis direction R of the jelly roll shape.

Gas generated during a charging and discharging process of a secondary battery vaporizes to an upper part of the jelly roll shape, resulting in the greatest pressure being applied to the flange part 542 located in the winding axis direction R of the jelly roll shape. Therefore, when the venting part 552 is formed at a sixth position 516 located in the winding axis direction R of the jelly roll shape of the flange part 542, the venting part 552 may be highly effective in suppressing an excessive increase in internal pressure of the secondary battery, as compared to a case where a venting part is formed at another position.

In some embodiments, a portion of the welded part 554 excluding the venting part 552 may include a plurality of first weld beads 520, and the venting part 552 may include a plurality of second weld beads 530 having a weaker bonding strength than the plurality of first weld beads 520. A welding depth of each second weld bead of the plurality of second weld beads 530 may be less than a welding depth of each first weld bead of the plurality of first weld beads 520.

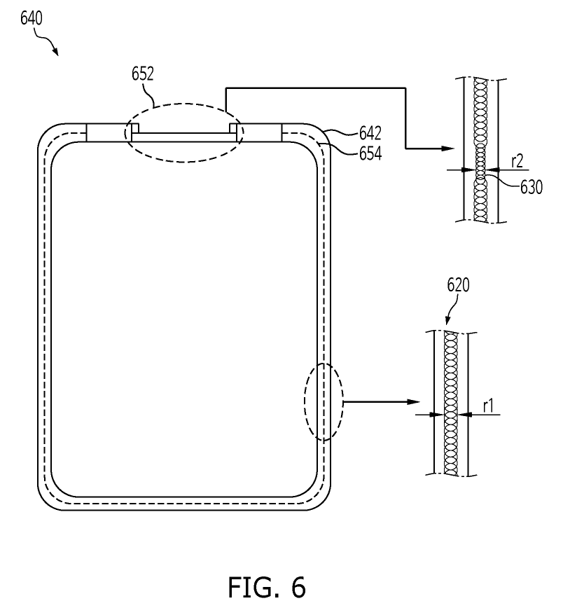

FIGS. 6-8 are diagrams illustrating cases 640, 740, and 840 for a secondary battery according to some embodiments of the present disclosure.

Among the configurations illustrated in FIGS. 6-8, configurations described or duplicated in FIGS. 1-5 are omitted.

Referring to FIG. 6, in a welded part 654 formed on a flange part 642, a diameter r2 of each second weld bead of a plurality of second weld beads 630 may be less than a diameter r1 of each first weld bead of a plurality of first weld beads 620. By further including the plurality of second weld beads 630 having a less diameter than the diameter r1 of the plurality of first weld beads 620 in a venting part 652, the venting part 652 may be more easily fractured than when only the plurality of first weld beads 620 are included, thereby effectively preventing a thermal runaway phenomenon of the secondary battery.

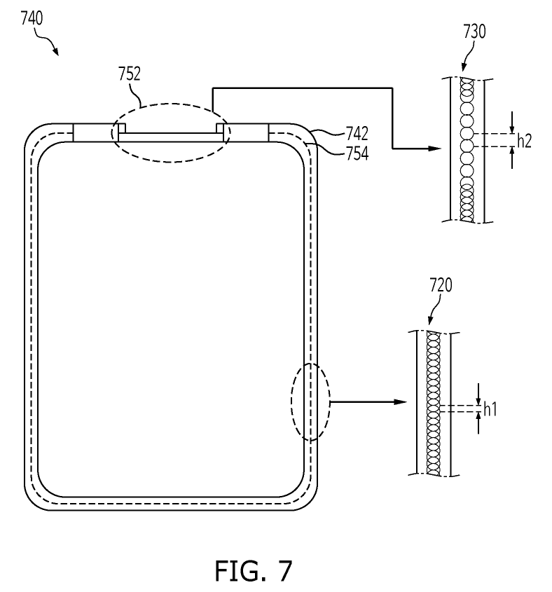

Referring to FIG. 7, in a welded part 754 formed on a flange part 742, an interval h2 between center points of adjacent second weld beads of a plurality of second weld beads 730 may be greater than an interval h1 between center points of adjacent first weld beads of a plurality of first weld beads 720. Thus, when comparing a section where the plurality of first weld beads 720 are formed in a remaining portion of the welded part 754 having the same length to a section where the plurality of second weld beads 730 of a venting part 752 are formed, a number of weld beads of the plurality of second weld beads 730 is less than a number weld beads of the plurality of first weld beads 720, so that the plurality of second weld beads 730 may have a weaker bonding strength than the plurality of first weld beads 720.

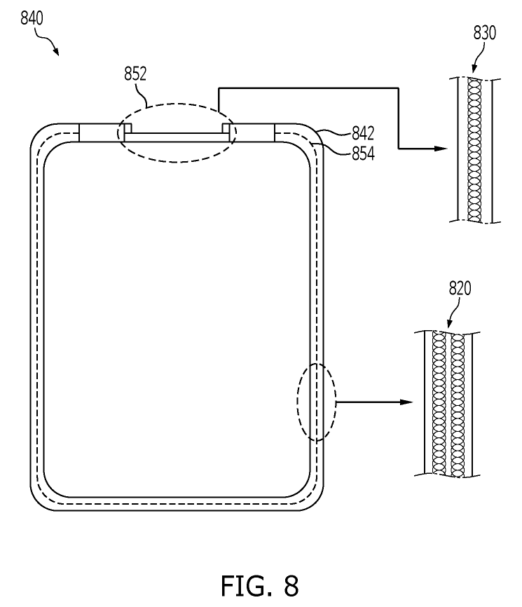

Referring to FIG. 8, in a welded part 854 formed on a flange part 842, weld beads of a plurality of second weld beads 830 may be formed in a single row, and weld beads of a plurality of first weld beads 820 may be formed in two parallel rows. As a result, in a venting part 852, the plurality of second weld beads 830 may fracture at a lower pressure than the plurality of first weld beads 820, thereby effectively preventing a thermal runaway phenomenon of the secondary battery.

Specifically, the venting part 852 may be formed by cutting (or severing) one row in the flange part 842 where a plurality of weld beads formed in two parallel rows were present. After joining an outer periphery of a secondary battery case with a plurality of weld beads formed in two parallel rows, by a process of forming the flange part 842, a portion to become the venting part 852 may be cut more concavely than a remaining portion to form the second weld bead 830 in a single row.

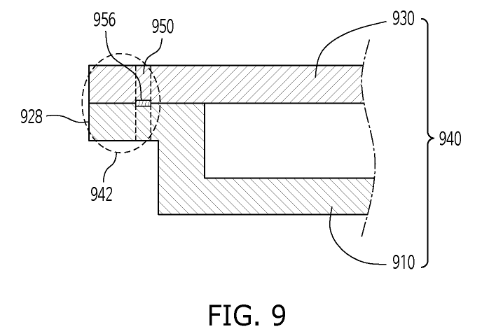

FIG. 9 is a cross-sectional view of a case for a secondary battery and a binding line of the case for the secondary battery according to some embodiments of the present disclosure.

Referring to FIG. 9, a binding line 950 according to some embodiments may have an adhesive part 956 where an extension part 928 and a cover 930 are joined by an adhesive. The adhesive part 956 may refer to a point where the extension part 928 and the cover 930 are integrally joined by an adhesive in a flange part 942 formed by coupling the extension part 928 of a body 920 and the cover 930 to each other so as to seal an accommodation part 129. By the adhesive part 956, the body 920 and the cover 930 of the secondary battery may be joined by welding to form a case 940, which is a single joined structure.

The adhesive part 956 may have electrical conductivity. An adhesive used to form the adhesive part 956 may include a metal-filled epoxy adhesive, a carbon-based conductive adhesive, a silicone-based conductive adhesive, an anisotropic conductive adhesive (ACA), or a combination thereof. However, the adhesive is not limited to the above descriptions, and various adhesives that may seal the case 940 may be used.

In some embodiments, the adhesive part 956 may be formed on a surface between the body 920 and the cover 930. The adhesive part 956 may have different bonding strengths for each adhered portion or position. An adhesive having different physical properties may be applied for each position of the adhesive part 956 to have different bonding strengths. Accordingly, the adhesive part 956 may have different bonding strengths at a venting part and a binding part.

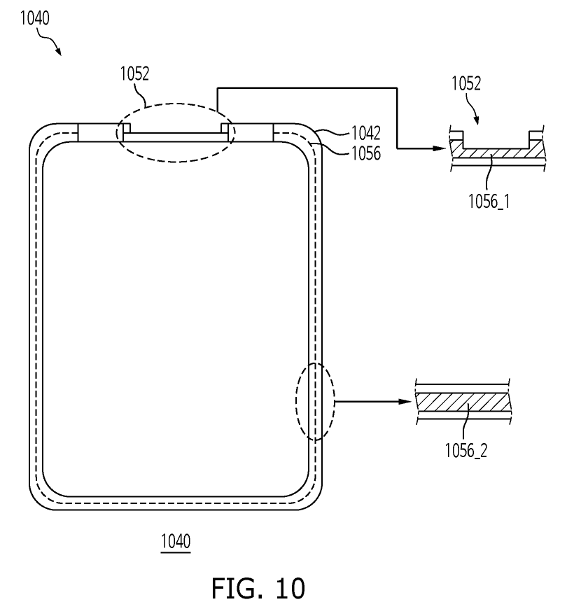

FIG. 10 is a diagram illustrating a case 1040 for a secondary battery according to some embodiments of the present disclosure. Among the configurations illustrated in FIG. 10, configurations described or duplicated in FIGS. 1-9 are omitted.

Referring to FIG. 8, an adhesive part 1056 may be formed along an edge or an outermost region of a case 1040. A venting part 1052 of the adhesive part 1056 may be configured to be fracturable by a predetermined pressure inside the case 1040. The venting part 1052 may be formed at any position among the positions where the adhesive part 1056 is formed, such as any position along the edge or the outermost region of the case 1040.

According to some embodiments, a portion of the adhesive part 1056 excluding the venting part 1052 may include a first adhesive part 1056_1, and the venting part 1052 may include a second adhesive part 1056_2. A width of the second adhesive part 1056_2 may be less than a width of the first adhesive part 1056_1.

In some embodiments, an adhesive for the first adhesive part 1056_1 and an adhesive for the second adhesive part 1056_2 may be the same. After joining an outer periphery of a secondary battery case using an adhesive to have a same width as the first adhesive part 1056_1, during a process of forming a flange part 1042, a portion to become a venting part 1052 may be cut more concavely than a remaining portion that forms the second adhesive part 1056_2. Since an amount of adhesive applied at the second adhesive part is less than an amount of adhesive applied at the first adhesive part 1056_1, the venting part 1052 may have a lower bonding strength than a remaining portion of the adhesive part 1056.

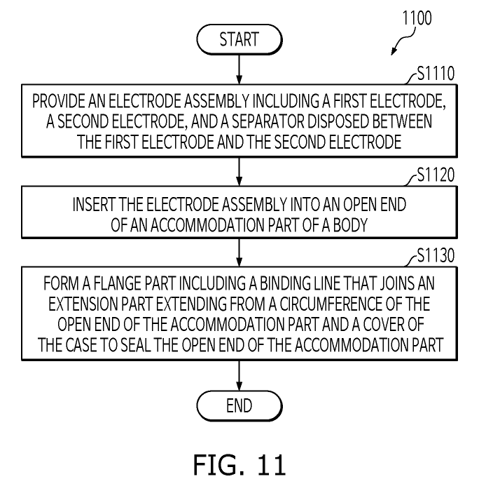

FIG. 11 is a flowchart illustrating a method of manufacturing a secondary battery according to some embodiments of the present disclosure.

Referring to FIG. 11, a method 1100 for manufacturing a secondary battery may be initiated with a step S1110 of providing an electrode assembly including a first electrode, a second electrode, and a separator disposed between the first electrode and the second electrode.

Next, the electrode assembly may be inserted into an open end of an accommodation part of a body S1120.

Thereafter, a flange part including a binding line, the flange part being where an extension part extending from an open end of the accommodation part around a circumference of the open end of the accommodation part and a cover of the case are joined, may be formed to seal the open end of the accommodation part S1130. The binding line includes a binding part that binds the extension part and the cover and a venting part that is fracturable by a predetermined internal pressure of the sealed accommodation part, and a portion of the flange part in which the venting part is disposed may be more concave than a remaining portion of the flange part where the binding part is located.

According to some embodiments, the step S1130 of forming the flange part may include a step of cutting the portion of the flange part in which the venting part is disposed to be more concave than the remaining portion of the flange part where the binding part is located.

According to some embodiments, the step S1130 of forming the flange part may include a step of joining the venting part after joining a portion of the binding line excluding the venting part. Referring to FIGS. 1 and 2, the binding line 150 may include a joining of a binding part 154 and a venting part 152.

According to some embodiments, the step S1110 of providing the electrode assembly includes a step of forming the electrode assembly in a jelly roll shape by sequentially winding the first electrode, the separator, and the second electrode, and, from the perspective of the plane of the flange part, the venting part may be located in the winding axis direction of the jelly roll shape.

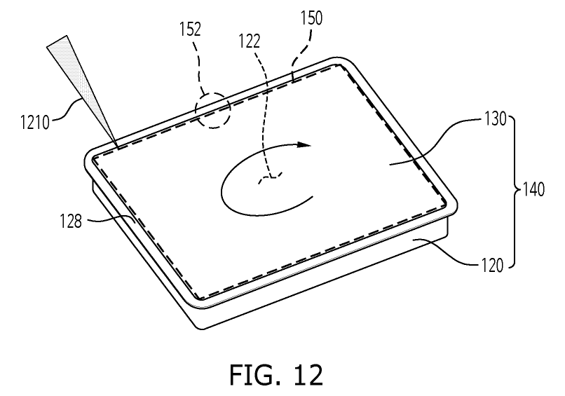

FIG. 12 is a diagram illustrating a step of welding a case for a secondary battery according to some embodiments of the present disclosure. Among the configurations illustrated in FIG. 12, descriptions of configurations described or duplicated in FIGS. 1-10 are omitted.

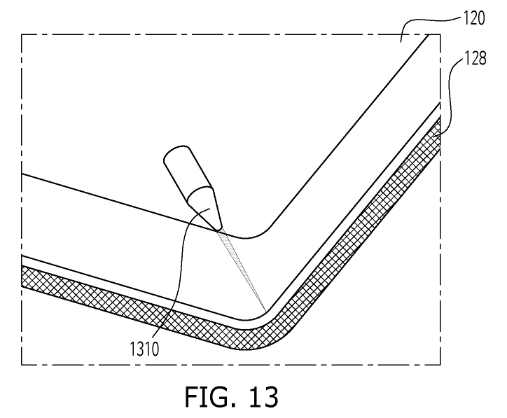

Referring to FIG. 12, a cover 130 disposed on an upper portion of a case 140 to seal an accommodation part 129 may be coupled with an extension part 128. The cover 130 may be coupled with the extension part 128 using a joining device 1210. The cover 130 and the extension part 128 may be joined through laser welding or the like. Additionally, or alternatively, the cover 130 and the extension part 128 may be joined through application of an adhesive or the like. According to some embodiments, the joining process may proceed clockwise along a line illustrated by a dotted line in FIG. 13 along a circumference of the extension part 128, but the joining process is not limited thereto.

According to some embodiments, the binding line 150 may be welded through a laser welding process performed a plurality of times. After first welding a portion of the binding line 150 excluding a venting part 152 to weld a plurality of first weld beads 220, the venting part 152 may be welded to weld a plurality of second weld beads 230. After first welding the portion of the binding line 150 excluding the venting part 152 to weld the plurality of first weld beads 220, the distance between a joining device 1210 and the secondary battery may be adjusted to form the venting part 152 and to thereby form the plurality of second weld beads 230.

FIG. 13 is a diagram illustrating a step of cutting a flange part according to some embodiments of the present disclosure.

Referring to FIG. 13, after a cover 130 is coupled with an extension part 128 as described with reference to FIG. 12, an outermost region of a flange part including a binding part and a venting part 152 that join the extension part 128 and the cover 130 (that is, at least a part of an outer region of a binding line 150) may be cut. According to some embodiments, the flange part may be cut using a cutting device 1310. The cutting device 1310 may be, for example, a laser cutting device. The flange part may be cut at an area extending from a body 120, but an area for cutting the flange part is not limited thereto.

In addition, during a process of cutting the flange part using the cutting device 1310, a portion of the flange part in which the venting part 152 is disposed may be cut to be more concave than a remaining portion of the flange part where a binding part is located.

Although the present disclosure has been described above with respect to embodiments thereof, the present disclosure is not limited thereto. Various modifications and variations can be made thereto by those skilled in the art within the spirit of the present disclosure.

### DESCRIPTION OF REPRESENTATIVE REFERENCE NUMERALS

100: secondary battery

110: electrode assembly

111: first electrode

112: first electrode tab

113: second electrode

114: second electrode tab

115: separator

120: body

122: first electrode terminal

124: second electrode terminal

126: electrolyte injection port

128: extension part

129: accommodation part

130: cover

140: case

150: binding line

152: venting part

What is claimed is:

1. A secondary battery comprising:
an electrode assembly comprising a first electrode, a second electrode, and a separator disposed between the first electrode and the second electrode; and
a case to accommodate the electrode assembly, wherein the case comprises:
a body comprising an accommodation part for accommodating the electrode assembly and an extension part extending from an open end of the accommodation part around a circumference of the open end of the accommodation part;
a cover coupled with the extension part to seal the open end of the accommodation part, the cover and the open end of the accommodation part configured to form a flange part when coupled together; and
a binding line on the flange part, the binding line comprising:
a binding part that binds the extension part and the cover; and
a venting part that is fracturable by a predetermined internal pressure of the accommodation part when sealed,
wherein a portion of the flange part in which the venting part is disposed is more concave than a remaining portion of the flange part where the binding part is located.

2. The secondary battery as claimed in claim 1, wherein the electrode assembly is of a jelly roll shape of which the first electrode, the separator, and the second electrode are wound, in that order, and
wherein, from a planar view of the flange part, the venting part is located in a plane of a winding axis direction of the jelly roll shape.

3. The secondary battery as claimed in claim 1, further comprising:
a first electrode terminal disposed on one side surface of the body and electrically connected to the first electrode; and
a second electrode terminal disposed on a same side surface of the body as the first electrode terminal and electrically connected to the second electrode.

4. The secondary battery as claimed in claim 3, wherein the venting part is disposed in a portion of the flange part located on a same side surface of the body as the first electrode terminal and the second electrode terminal.

5. The secondary battery as claimed in claim 3, wherein the flange part comprises a first portion corresponding to a position of the first electrode terminal and a second portion corresponding to a position of the second electrode terminal, and
wherein the portion of the flange part in which the venting part is disposed is between the first portion and the second portion.

6. The secondary battery as claimed in claim 1, wherein a width of the portion of the flange part in which the venting part is disposed is from about 10% to about 50% of a width of the remaining portion of the flange part where the binding part is located.

7. The secondary battery as claimed in claim 1, wherein a width of the portion of the flange part in which the venting part is disposed is from about 0.05 mm to about 0.1 mm, and
wherein a width of the remaining portion of the flange part where the binding part is located is from about 0.2 mm to about 0.3 mm.

8. The secondary battery as claimed in claim 1, wherein the binding line comprises a welded part where the extension part and the cover are joined by welding.

9. The secondary battery as claimed in claim 8, wherein a portion of the welded part excluding the venting part comprises a plurality of first weld beads, and
wherein the venting part comprises a plurality of second weld beads comprising a weaker bonding strength than the plurality of first weld beads.

10. The secondary battery as claimed in claim 9, wherein a diameter of each second weld bead of the plurality of second weld beads is less than a diameter of each first weld bead of the plurality of first weld beads.

11. The secondary battery as claimed in claim 9, wherein an interval between center points of adjacent second weld beads of the plurality of second weld beads is greater than an interval between center points of adjacent first weld beads the plurality of first weld beads.

12. The secondary battery as claimed in claim 9, wherein a welding depth of the plurality of second weld beads is less than a welding depth of the plurality of first weld beads.

13. The secondary battery as claimed in claim 9, wherein second weld beads forming the plurality of second weld beads are positioned in a single row, and
wherein first weld beads forming the plurality of first weld beads are positioned in two parallel rows.

14. The secondary battery as claimed in claim 1, wherein the binding line comprises an adhesive part where the extension part and the cover are joined by an adhesive.

15. The secondary battery as claimed in claim 14, wherein a portion of the adhesive part excluding the venting part comprises a first adhesive part,
wherein the venting part comprises a second adhesive part, and
wherein a width of the second adhesive part is less than a width of the first adhesive part.

16. The secondary battery as claimed in claim 1, wherein the body and the cover comprise a same metallic material.

17. The secondary battery as claimed in claim 1, wherein the body and the cover comprise stainless steel.

18. A method of manufacturing a secondary battery, the method comprising:
providing an electrode assembly comprising a first electrode, a second electrode, and a separator disposed between the first electrode and the second electrode;
inserting the electrode assembly into a case via an open end of an accommodation part of a body of the case;
forming a flange part of the case, the flange part comprising a binding line that joins an extension part extending from a circumference of the open end of the accommodation part; and
forming a cover of the case to seal the open end of the accommodation part,
wherein the binding line comprises a binding part for binding the extension part and the cover, and a venting part that is fracturable by a predetermined internal pressure of the sealed accommodation part, and
wherein a portion of the flange part in which the venting part is disposed is more concave than a remaining portion of the flange part where the binding part is located.

19. The method of manufacturing a secondary battery as claimed in claim 18, wherein the forming the flange part comprises cutting the portion of the flange part in which the venting part is disposed to be more concave than the remaining portion of the flange part where the binding part is located.

20. The method of manufacturing a secondary battery as claimed in claim 18, wherein the providing comprises forming the electrode assembly in a jelly roll shape by sequentially winding the first electrode, the separator, and the second electrode, and
wherein the method further comprises positioning the venting part such that, from a planar view of the flange part, the venting part is located in a plane of a winding axis direction of the jelly roll shape.
